(19) United States
(12) Patent Application Publication
(10) Pub. No.: US 2021/0263384 A1
(43) Pub. Date: Aug. 26, 2021

(54) DISPLAY DEVICE

(71) Applicant: SAKAI DISPLAY PRODUCTS CORPORATION, Sakai-shi, Osaka (JP)

(72) Inventor: EIJI NAKAMURA, Sakai-shi, Osaka (JP)

(21) Appl. No.: 17/255,858

(22) PCT Filed: Jun. 29, 2018
(86) PCT No.: PCT/JP2018/024903

§ 371 Date: Dec. 23, 2020

(51) Int. Cl. G02F 1/1362; G02F 1/1368; G09G 3/36

(52) U.S. Cl. CPC G02F 1/136286; G09G 3/3696; G02F 1/1368

(57) ABSTRACT

This display apparatus comprises: a plurality of pixels arrayed along a plurality of rows and a plurality of columns; a plurality of signal lines connected to the plurality of pixels respectively for each row; a drive circuit for generating a plurality of control signals to selectively turn the plurality of pixels on and off by rows, the drive circuit applying the control signals to the signal lines; a power supply circuit for supplying the drive circuit with a voltage for generating each control signal; and at least one inductor connected between the power supply circuit and the plurality of signal lines.

### TECHNICAL FIELD

The invention relates to a display apparatus comprising a plurality of pixels arrayed along a plurality of rows and a plurality of columns.

### BACKGROUND ART

In a flat display panel such as a liquid crystal display apparatus, work to further improve the resolution thereof, such as FHD (Full High Definition), 4K, or 8K, is underway. By improving the resolution, or, in other words, increasing the number of scanning lines, a need arises to drive a switching element of each pixel at a higher speed.

For example, Patent document 1 discloses a liquid crystal display apparatus to AC drive a liquid crystal element at a higher speed than in a conventional one, and visually reduce interference noise on neighboring wirings, and display a high quality image.

### PRIOR ART DOCUMENT

### Patent Document

Patent Document 1: JP 2011-028159 A

### SUMMARY OF THE INVENTION

### Problem to be Solved by the Invention

A switching element of each pixel has a given gate capacitance. Moreover, a gate signal line connected to the gate of the switching element of each pixel has a given resistance. Therefore, a CR circuit is formed by the gate capacitance of the switching element and the resistance of the signal line. When the switching element of each pixel is turned on or off, the CR circuit is charged or discharged.

In accordance with the characteristics of the CR circuit, in a case that the CR circuit is charged, for example, a large current flows only at the moment a power supply is turned on and the circuit is charged rapidly, but the charge speed gradually slows down, so that it takes a long time for the circuit to reach the power supply potential. Also, in a case of discharging from the CR circuit, it takes a long time for the circuit to reach the ground potential.

Moreover, in the CR circuit having a capacitance C and a resistance R, when charging to the circuit is carried out from the power supply of a voltage V, energy CV²/2 charged to the capacitance C and loss energy R·I(rms)²=CV²/2 consumed by the resistance R occurs. Here, I(rms) denotes the effective value of current.

An object of the invention is to provide a display apparatus that operates at a higher speed with respect to a display apparatus according to the conventional art and further reduces loss.

### Means to Solve the Problem

A display apparatus according to one aspect of the present invention comprises: a plurality of pixels arrayed along a plurality of rows and a plurality of columns; a plurality of signal lines connected to the plurality of pixels, respectively, for each of the rows; a drive circuit to generate a plurality of control signals and apply the plurality of control signals to each of the signal lines, wherein the plurality of control signals selectively turns on and off the plurality of pixels for each of the rows; a power supply circuit to supply a voltage for generating each of the control signals to the drive circuit; and at least one inductor being connected between the power supply circuit and the plurality of signal lines.

### Effects of the Invention

In a display apparatus according to one aspect of the present invention, an inductor is provided, thereby making it possible to operate at a higher speed with respect to a display apparatus according to the conventional art and further reduce loss.

### BRIEF DESCRIPTION OF THE DRAWINGS

FIG. 1 shows a block diagram of the configuration of a display apparatus according to a first embodiment.

FIG. 2 shows a circuit diagram of the detailed configuration of each pixel in FIG. 1.

FIG. 3 shows an equivalent circuit diagram of one of gate signal lines and a plurality of pixels connected to the gate signal line in FIG. 1.

FIG. 4 shows a graph indicating a change in voltage and current of the gate signal line when a gate control signal is transitioned from a low level to a high level in one of the gate signal lines in FIG. 1.

FIG. 5 shows a graph indicating a change in voltage and current of the gate signal line when the gate control signal is transitioned from the high level to the low level in one of the gate signal lines in FIG. 1.

FIG. 6 shows a table showing an optimal value of inductance of an inductor in FIG. 1.

FIG. 7 shows a block diagram of the configuration of the display apparatus according to a second embodiment.

FIG. 8 shows a graph indicating a change in voltage and current of the gate signal line when the gate control signal is transitioned from the low level to the high level in one of the gate signal lines in the display apparatus according to the comparative examples.

FIG. 9 shows a graph indicating a change in voltage and current of the gate signal line when the gate control signal is transitioned from the low level to the high level in one of the gate signal lines in FIG. 7.

### EMBODIMENT FOR CARRYING OUT THE INVENTION

Below, with reference to the drawings, a display apparatus according to each embodiment of the present invention is described. In each drawing, the same letters denote the same constituting elements.

### First Embodiment

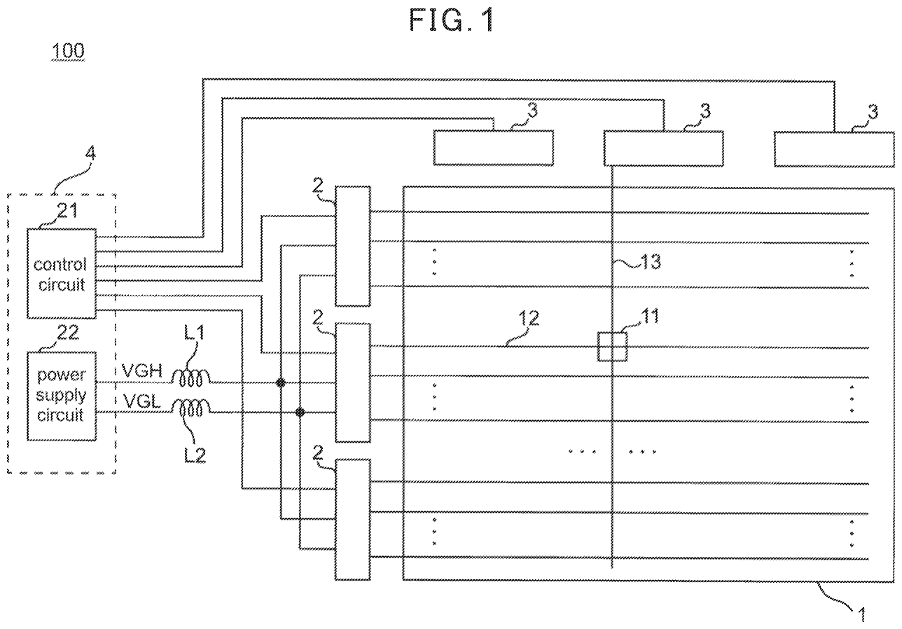

FIG. 1 shows a block diagram of the configuration of a display apparatus 100 according to a first embodiment. The display apparatus 100 comprises a display panel 1, one or more gate drive circuits 2, one or more source drive circuits 3, a timing controller 4, and inductors L1, L2.

The display panel 1 comprises a plurality of pixels 11 arrayed along the row direction (the horizontal direction in FIG. 1) and the column direction (the vertical direction in FIG. 1), a plurality of gate signal lines 12 along a plurality of rows, and a plurality of source signal lines 13 along a plurality of columns. Each of the pixels 11 is connected to each of the gate signal line 12 and to each of the source signal line 13. In other words, each of the pixels 11 is arrayed along the plurality of rows and the plurality of columns, and each of the gate signal lines 12 is connected to each one of the plurality of pixels 11 for each of the rows, while each of the source signal lines 13 is connected to each one of the plurality of pixels 11 for each of the columns. The display panel 1 is a liquid crystal panel, for example.

The gate drive circuit 2 generates a plurality of gate control signals that selectively turns on and off the plurality of pixels 11 for each row and applies the plurality of gate control signals to each of the gate signal lines 12. Turning on each of the pixels 11 causes a (below described) switching element in the pixel 11 to be turned on, causing a capacitor and a display element inside the pixel 11 to be connected to the source signal line 13.

The source drive circuit 3 supplies a plurality of source control signals indicating the grayscale of each of the pixels of an image along one of the plurality of rows to each of the pixels 11 via the plurality of source signal lines 13.

The timing controller 4 comprises a control circuit 21 and a power supply circuit 22. The control circuit 21 controls the gate drive circuit 2 and the source drive circuit 3. The power supply circuit 22 supplies, to the gate drive circuit 2, voltages VGH, VGL for generating each of the gate control signals. The voltage VGH is higher than a threshold voltage to turn on each of the pixels 11, while the voltage VGL is lower than the threshold voltage. In this specification, the voltage VGH is also called “a first voltage” while the voltage VGL is also called “a second voltage”.

The inductances L1, L2 are connected between the power supply circuit 22 and the plurality of gate signal lines 12, or, particularly, between the power supply circuit 22 and the gate drive circuit 22. The power supply circuit 22 supplies the voltage VGL to the gate drive circuit 22 via the inductor L1 and the voltage VGL to the gate drive circuit 22 via the inductor L2. In this specification, the inductor L1 is also called “a first inductor” while the inductor L2 is also called “a second inductor”.

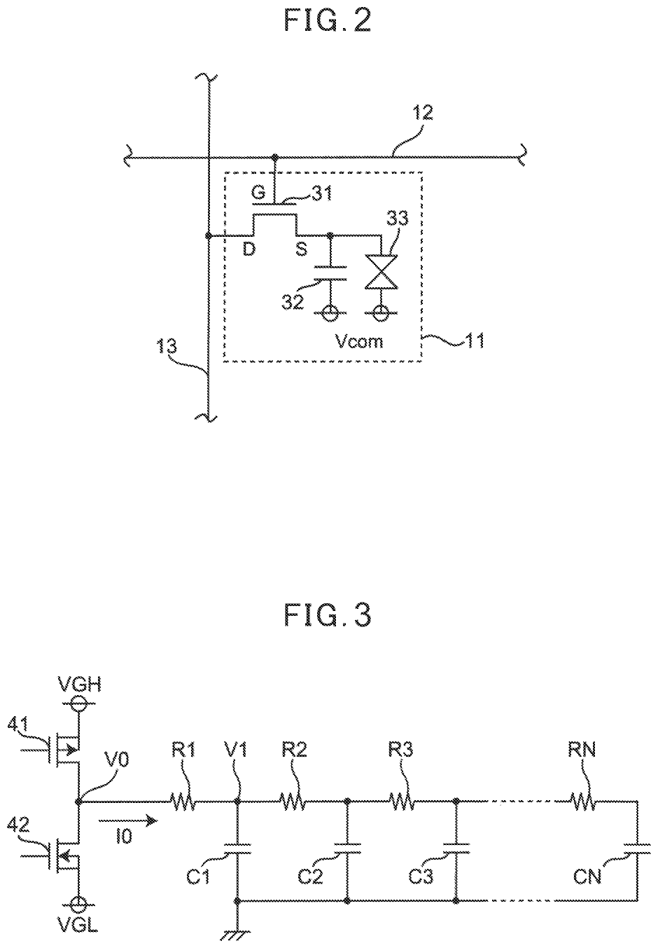

FIG. 2 shows a circuit diagram of the detailed configuration of each of the pixels 11 in FIG. 1. The pixel 11 comprises a switching element 31, a capacitor 32, and a display element 33. The switching element 31 turns on and off in accordance with the gate control signal. The switching element 31 is a thin-film transistor, for example. The capacitor 32 and the display element 33 are connected in parallel with each other, one end of these elements is connected to the source signal line 13 via the switching element 31, while the other end of these elements is connected to the terminal of a predetermined common voltage Vcom. The capacitor 32 is a capacitive element to be charged in accordance with the voltage of the source control signal. The display element 33 has an optical property of changing in accordance with the voltage between the opposite ends of the capacitor 32. The display element 33 is a liquid crystal, for example.

The gate control signal input to the display panel 1 from the gate drive circuit 2 propagates through the gate signal line 12 and is applied to the gate terminal of the switching element 31 of each of the pixels 11. Moreover, the source control signal input to the display panel 1 from the source drive circuit 3 propagates through the source signal line 13 and is applied to the drain terminal of the switching element 31 of each of the pixels 11. When the voltage of the gate control signal being applied to the gate terminal of the switching element 31 rises to exceed a threshold voltage Vth of the switching element 31, the switching element 31 is turned on to cause the drain and the source to conduct with each other. Here, the voltage of the source control signal being applied to the drain terminal of the switching element 31 is supplied to the pixel 11 through the source terminal of the switching element 31 and the capacitor 32 is charged (discharged) in accordance with the voltage of the source control signal.

FIG. 3 shows an equivalent circuit diagram of one of the gate signal lines 12 in FIG. 1 and the plurality of pixels 11 connected to the gate signal line 12. For each of the gate signal lines 12, the gate drive circuit 2 comprises switching elements 41, 42 to apply, to the gate signal line 12, one of the voltages VGH, VGL selectively. Each of the switching elements 41, 42 operates in accordance with a control signal from the control circuit 21. With reference to FIG. 3, R1 to RN denote resistance that one gate signal line 12 itself has. Moreover, C1 to CN denote a gate capacitance of the switching element 31 of each of the pixels 11 connected to the one gate signal line 12.

As described previously, a CR circuit is formed by the gate capacitance of the switching element 31 of each of the pixels 11 and the resistance of the gate signal line 12. The time when the gate control signal is transitioned from the low level to the high level or when it is transitioned in reverse thereof increases due to the CR circuit. Moreover, energy consumed by the resistance is lost when a voltage is applied to the gate capacitance to carry out charging due to the CR circuit. In this regard, in the display apparatus 100 according to the embodiment, as described below, the inductors L1, L2 are provided, thereby causing the display apparatus 100 to operate at a higher speed with respect to a display apparatus according to the conventional art, and further reducing loss.

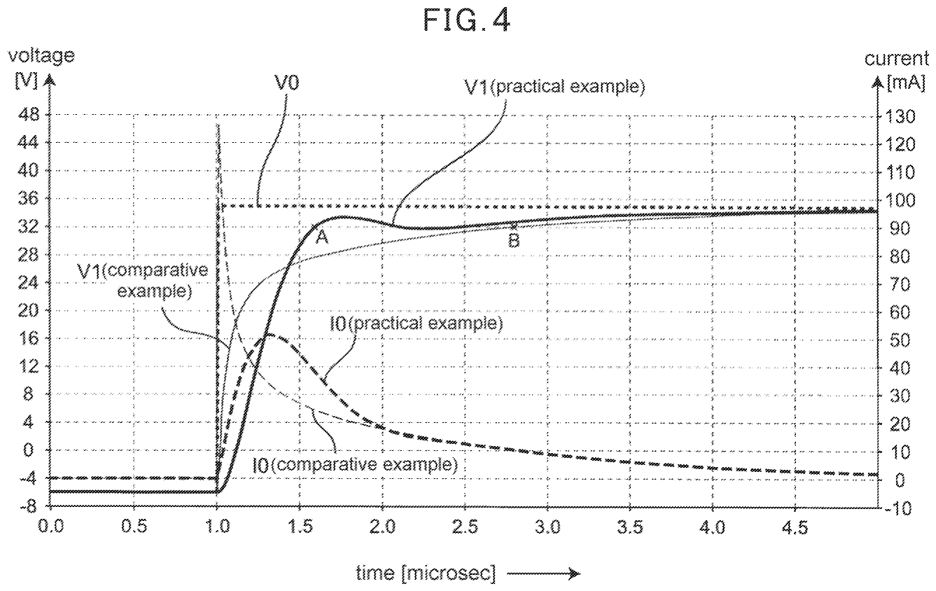

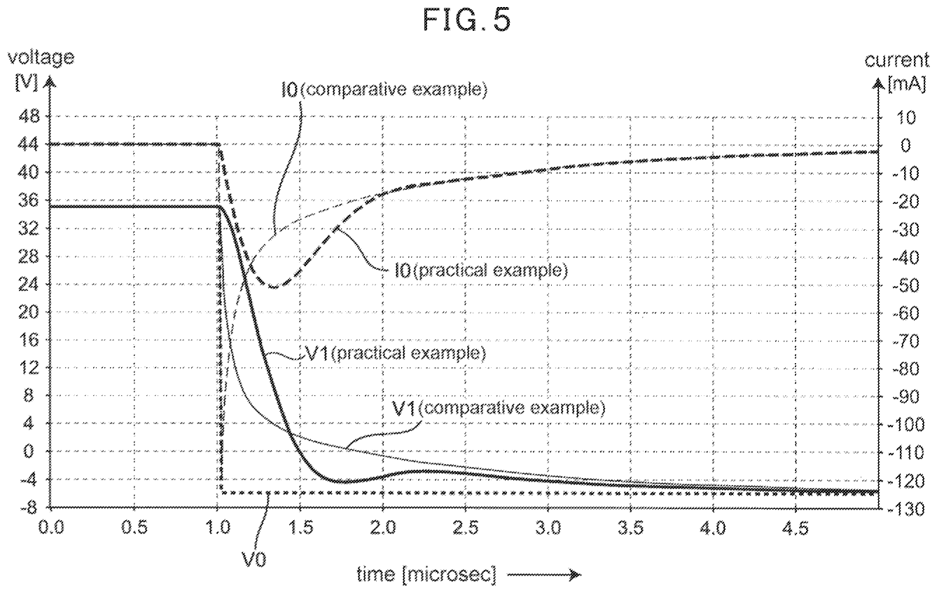

Next, with reference to FIGS. 4 and 5, simulation results showing the advantageous effects of providing the inductors L1, L2 are described.

In simulation results in FIGS. 4 and 5, in the equivalent circuit in FIG. 3, a case in which seven of the pixels 11 are connected to the one gate signal line 12 is assumed (In other words, C1 to C7, R1 to R7). Each of the gate capacitances C1 to C7 is set to 200 pF. Each of the resistances R1 to R7 is set to 300Ω. Moreover, the inductance of each of the inductors L1, L2 is set to 120 μH. Furthermore, the voltage VGH is set to 35V while the voltage VGL is set to −6V. In the simulation, a change in a voltage V1 and a current 10 in the equivalent circuit in FIG. 3 is investigated for the display apparatus 100 according to a practical example in which the inductors L1, L2 are provided, and a display apparatus according to a comparative example in which an inductor is not provided.

FIG. 4 shows a graph indicating a change in voltage and current of the gate signal line 12 when a gate control signal is transitioned from a low level to a high level in one of the gate signal lines 12 in FIG. 1.

With reference to FIG. 4, according to a comparative example, it is taking a long time for a voltage V1 to approach, after a voltage V0 of the node between the switching elements 41, 42 is transitioned to a high level, the potential of the voltage V0 due to the CR circuit. For example, assuming that the threshold voltage to turn on the switching element 31 of each of the pixels 11 is 32V, it takes 1.8 microsecs for the voltage V1 to reach 32V (point B) after the voltage V0 transitions to the high level. On the other hand, according to the practical example, the voltage V1 approaches the potential of the voltage V0 in a shorter time than in a case of the comparative example after the voltage V0 transitions to the high level by providing the inductor L1. For example, the time from when the voltage V0 transitions to the high level to when the voltage V1 reaches 32V (point A) is shortened to 0.6 microsec.

Moreover, with reference to FIG. 4, according to the comparative example, at the moment the voltage V0 transitions to the high level, the current I0 being very large abruptly flows. On the other hand, according to the practical example, an increase in the current I0 is smaller with respect to a case of the comparative example after the voltage V0 transitions to the high level by providing the inductor L1.

FIG. 5 shows a graph indicating a change in voltage and current of the gate signal line 12 when the gate control signal is transitioned from the high level to the low level in one of the gate signal lines 12 in FIG. 1.

With reference to FIG. 5, according to the comparative example, it is taking a long time for a voltage V1 to approach the potential of the voltage V0 after the voltage V0 is transitioned to the low level due to the CR circuit. On the other hand, according to the practical example, the voltage V1 approaches the potential of the voltage V0 in a shorter time than the case of the comparative example after the voltage V0 transitions to the low level by providing the inductor L2.

Moreover, with reference to FIG. 5, according to the comparative example, at the moment the voltage V0 transitions to the low level, the current I0 being very large abruptly flows. On the other hand, according to the practical example, an increase in the current I0 is smaller with respect to a case of the comparative example after the voltage V0 transitions to the low level by providing the inductor L2.

According to FIGS. 4 and 5, it is evident that the display apparatus 100 according to the practical example can operate at a higher speed with respect to the display apparatus according to the comparative example by providing the inductors L1, L2. Moreover, according to FIGS. 4 and 5, it is evident that the display apparatus 100 according to the practical example can greatly reduce peak current and further reduce loss generated by resistance of the gate signal line 12 by providing the inductors L1, L2.

In the display apparatus 100 according to the practical example, an LCR circuit is formed by the gate capacitance of the switching element 31 of each of the pixels 11, the resistance of the gate signal line 12, and the inductors L1, L2.

According to research by the inventor of the present application, it was found that the inductors L1, L2 preferably have the inductance as follows to shorten the time to charge and discharge with respect to the gate capacitance of the switching element 31 of each of the pixels 11. It is assumed that the gate drive circuit 2 invariably applies a high-level gate control signal to only one of the gate signal lines 12, while it applies a low-level gate control signal to the other gate signal lines 12. The inductance of the inductors L1, L2 is set to be, for example, in the order of 10⁻⁷ to 10⁻⁶ times the product of the square of a resistance Rsum of the one gate signal line 12 and a sum total Csum of the gate capacitance of the switching element 31 of each of the pixels 11 connected to the one gate signal line 12.

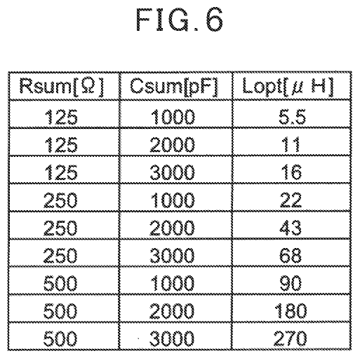

FIG. 6 shows a table showing an optimal value of inductance of the inductors L1, L2 in FIG. 1. According to research by the inventor of the present application, it was found that the time to charge and discharge with respect to the gate capacitance of the switching element 31 of each of the pixels 11 can be shortened most when the inductance of the inductors L1, L2 is set to be 1/2830000 with respect to the product of the square of the resistance Rsum and the capacitance Csum. Here, the inductance of the inductors L1, L2 amounts to the optimal value Lopt=Rsum²×Csum/2830000. The inventor of the present application confirmed, by changing the inductance of the inductors L1, L2 to three times the optimal value Lopt in FIG. 6 from 0 μH through the simulation, that the time for charging and discharging can be shortened most when the inductors L1, L2 have the inductance having the optimal value Lopt. Therefore, it was found that the above-described equation including the proportional constant “1/2830000” is satisfied well under various resistance Rsum and various capacitance Csum terms.

In a case the gate drive circuit 2 applies a high level gate control signal to the plurality of gate signal lines 12 simultaneously, load applied to the gate drive circuit 2 (in other words, the gate capacitance of the switching element 31 of each of the pixels 11 and the resistance of the gate signal line 12) increases. Even in this case, the optimal value Lopt of the inductance of the inductors L1, L2 can be appropriately determined in accordance with the magnitude of load applied to the gate drive circuit 2.

### Second Embodiment

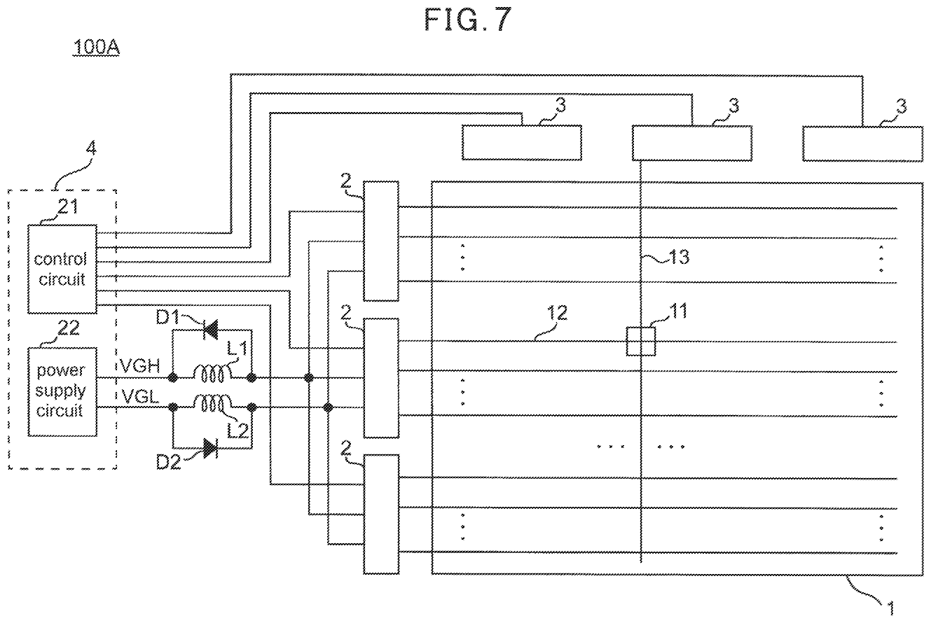

FIG. 7 shows a block diagram of the configuration of a display apparatus 100A according to a second embodiment. The display apparatus 100A in FIG. 7 comprises diodes D1, D2 in addition to each constituting element of the display apparatus 100 in FIG. 1.

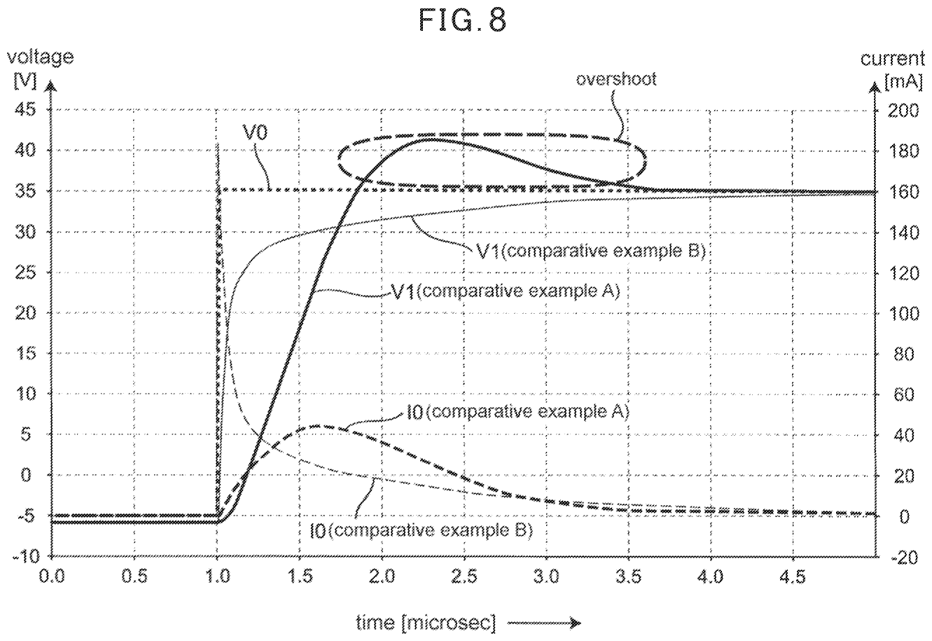

FIG. 8 shows a graph indicating a change in voltage and current of the gate signal line 12 when the gate control signal is transitioned from the low level to the high level in one of the gate signal lines 12 in the display apparatus according to the comparative examples. Here, a comparative example A shows a display apparatus comprising the inductors L1, L2 as shown in FIG. 1 and not comprising a diode. Moreover, as in the comparative example referred to inn FIGS. 4 and 5, a comparative example B shows a display apparatus comprising neither an inductor nor a diode. An overshoot of the gate control signal can occur by providing the inductors L1, L2 as shown in FIG. 1. According to the comparative example A, a voltage V1 temporarily exceeds a voltage V0 (in other words, a voltage VGH of a power supply circuit) by providing the inductor L1.

Similarly, when the gate control signal is transitioned from the high level to the low level as well, the voltage V1 temporarily decreases with respect to the voltage V0 (or, in other words, a voltage VGL of the power supply circuit) by providing the inductance L2.

To make it difficult for such an overshoot to occur, the display apparatus 100A comprises the diodes D1, D2. The diode D1 is connected in parallel to the inductor L1 such that current flows in the orientation in which an overshoot of a voltage of each of the gate control signals is eliminated with the voltage VGH of the power supply circuit 22 as a reference, or, in other words, the current flows toward the power supply circuit 22 from each of the gate signal lines 12. The diode D2 is connected in parallel to the inductor L2 such that current flows in the orientation in which an overshoot of a voltage of each of the gate control signals is eliminated with the voltage VGL of the power supply circuit 22 as a reference, or, in other words, toward each of the gate signal lines 12 from the power supply circuit 22.

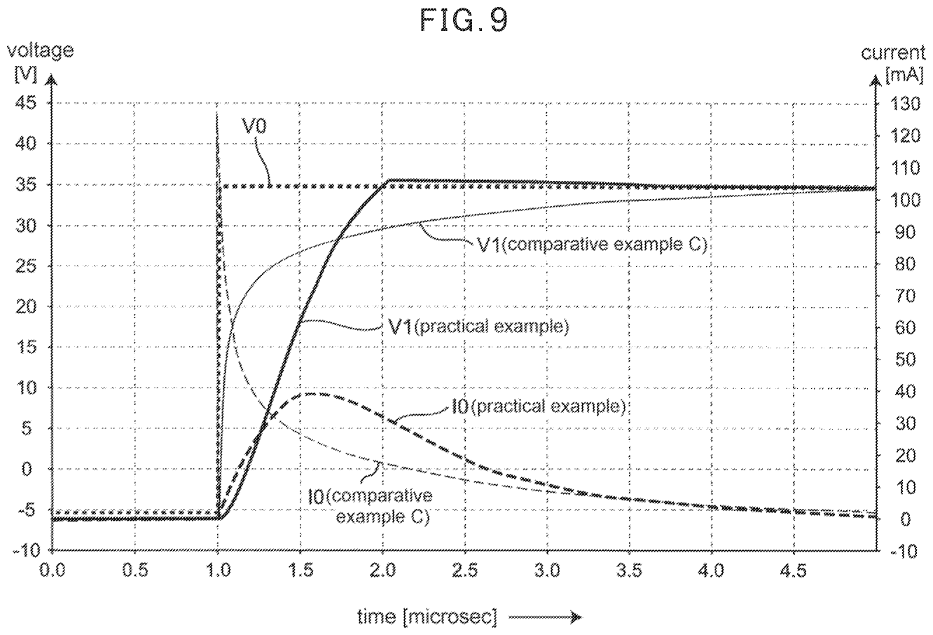

FIG. 9 shows a graph indicating a change in voltage and current of the gate signal line 12 when the gate control signal is transitioned from the low level to the high level in one of the gate signal lines in FIG. 7. Here, a practical example shows the display apparatus 100A comprising both the inductors L1, L2 and the diodes D1, D2. Moreover, as in the comparative example referred to in FIGS. 4 and 5, a comparative example C shows a display apparatus comprising neither the inductor nor the diode. According to FIG. 9, it is evident that providing the diode Di causes the voltage V1 to be equal to the voltage VGH of the power supply circuit, causing an overshoot of the gate control signal to be eliminated.

For transitioning the gate control signal from the high level to the low level as well, providing the diode D2 causes the voltage V1 to be equal to the voltage VGL of the power supply circuit, causing an overshoot of the gate control signal to be eliminated.

### Variation

The inductor is construed to be riot limited to be located between the power supply circuit 22 and each of the gate signal lines 12, so that it can be provided at a different arbitrary position, as long as an LCR circuit is formed with the gate capacitance of the switching element 31 of each of the pixels 11 and the resistance of the gate signal line 12. For example, the inductors can be provided separately for each of the gate signal lines 12. In this case, each of the inductors can be provided inside the gate drive circuit 2, can be provided in the display panel 1, or can be provided between the gate drive circuit 2 and the display panel 1.

The display apparatus can be provided with a gate drive circuit not only on one side of each of the gate signal lines 12, but on both sides thereof. Also in this case, in the same manner as each of the embodiments described in this specification, an inductor can be provided between the power supply circuit and each of the gate drive circuits (or at another position).

The present invention makes it possible to provide a display apparatus that operates at a higher speed with respect to a display apparatus according to the conventional art and further reduces loss.

### DESCRIPTION OF REFERENCE NUMERALS

1 . . . DISPLAY PANEL
2 . . . GATE DRIVE CIRCUIT
3 . . . SOURCE DRIVE CIRCUIT
4 . . . TIMING CONTROLLER
11 . . . PIXEL
12 . . . GATE SIGNAL LINE
13 . . . SOURCE SIGNAL LINE
21 . . . CONTROL CIRCUIT
22 . . . POWER SUPPLY CIRCUIT
31 . . . SWITCHING ELEMENT
32 . . . CAPACITOR
33 . . . DISPLAY ELEMENT
41, 42 . . . SWITCHING ELEMENT
100, 100A . . . DISPLAY APPARATUS
C1 to CN . . . GATE CAPACITANCE
D1, D2 . . . DIODE
L1, L2 . . . INDUCTOR
R1 to RN . . . RESISTANCE

1. A display apparatus comprising:
a plurality of pixels arrayed along a plurality of rows and a plurality of columns;
a plurality of gate signal lines connected to the plurality of pixels, respectively, for each of the rows;
a plurality of source signal lines connected to the plurality of pixels, respectively, for each of the columns;
a drive circuit to generate a plurality of control signals and apply the plurality of control signals to each of the gate signal lines, wherein the plurality of control signals selectively turns on and off the plurality of pixels for each of the rows; and
a power supply circuit to supply a voltage for generating each of the control signals to the drive circuit, wherein
each of the plurality of pixels comprises:
a switching element, comprising a gate terminal being connected to any one of the plurality of gate signal lines, to turn on and off in accordance with the control signal applied to the gate terminal; and
a liquid crystal display element being connected to one of the source signal lines via the switching element, and
the display apparatus further comprises at least one inductor being connected between the power supply circuit and the plurality of gate signal lines.

2. The display apparatus according to claim 1, wherein
each of the pixels has a given gate capacitance; and
the inductor has an inductance being in an order of 10⁻⁷ to 10⁻⁶ times a product of a square of a resistance of one gate signal line in the plurality of gate signal lines and a sum total of a gate capacitance of each of the pixels connected to the one gate signal line.

3. The display apparatus according to claim 2, wherein
the inductor has an inductance being 1/2830000 times a product of a square of a resistance of one gate signal line in the plurality of gate signal lines and a sum total of a gate capacitance of each of the pixels connected to the one gate signal line.

4. The display apparatus according to claim 1, further comprising a diode being connected in parallel to the inductor such that current flows in an orientation in which an overshoot of a voltage of each of the control signals is eliminated with a voltage of the power supply circuit as a reference.

5. The display apparatus according to claim 1, wherein the inductor is connected between the power supply circuit and the drive circuit.

6. The display apparatus according to claim 5, wherein
the display apparatus comprises a first inductor and a second inductor; and
the power supply circuit
supplies, to the drive circuit via the first inductor, a first voltage higher than a threshold voltage to turn on each of the pixels; and
supplies, to the drive circuit via the second inductor, a second voltage lower than the threshold voltage.
